(19) United States
(12) Patent Application Publication
(10) Pub. No.: US 2016/0022379 A1
(43) Pub. Date: Jan. 28, 2016

(54) Assemblies For Improved Periodontal Surgery And Recovery Therefrom

(71) Applicant: Duane C. Keller, St. Louis, MO (US)

(72) Inventor: Duane C. Keller, St. Louis, MO (US)

(21) Appl. No.: 14/807,519

(22) Filed: Jul. 23, 2015

Related U.S. Application Data
(60) Provisional application No. 62/028,178, filed on Jul. 23, 2014.

(51) Int. Cl. A61C 5/12; A61C 19/06

(52) U.S. Cl. CPC A61C 5/12; A61C 19/063

(57) ABSTRACT

Assemblies and apparatus for supporting gum tissue during and after periodontal surgery using a tray having a body with a buccal wall, a lingual wall, a tooth covering portion forming a cavity defining internal recesses for the enclosed teeth, in one embodiment a raised seal formed longitudinally on an inner surface of one of the walls along its gum line and applying a biasing pressure thereto to support and stabilize the gum tissue to prevent deflection and alteration, the opposing wall extends substantially from the exposed portion of the tooth to enclose a spaced apart portion of the corresponding gum tissue therefrom and a contoured cavity extends outward from the gum tissue along the gum line forming a medicament holding chamber between an inner surface of the opposing wall and its corresponding gum tissue.

### CROSS-REFERENCE TO RELATED APPLICATIONS

This application claims the benefit of U.S. Provisional Application No. 62/028,178, filed on Jul. 23, 2014, the disclosure of which is incorporated herein by reference.

### FIELD

The present disclosure relates to periodontal surgery and, more specifically, to assemblies and methods to aid in post-operative recovery following periodontal surgery.

### BACKGROUND

The statements in this section merely provide background information related to the present disclosure and may not constitute prior art.

Oral surgery is often performed on the buccal and/or lingual gingiva or buccal gum tissue of a dental patient for a variety of reasons. These are most commonly performed to improve periodontal health of the patient, to improve aesthetics, or to correct destruction of gingival tissue that resulted from periodontal disease or other causes.

In one situation, periodontal disease results in the loss of bone supporting a tooth, the lost bone can be reconstructed through techniques such as guided bone regeneration. Also, oral surgery is often also required where teeth and dental implants are required. Reconstruction of the periodontal and gingival tissues through periodontal plastic and reconstructive surgery often involves surgical procedures such as re-contouring of gum tissue as well as multi-stage grafting. In other situations, minimal invasive removal of excess gum tissue and sculpting of the gum line including sculpting of the underlying bone is required. Gum grafts are often provided to cover exposed roots or to provide adequate supportive tissue for teeth and dental implants. These can also include tissue graft grafting for reconstruction of defects surgically created during other oral surgery procedures including those of the buccal mucosa. In such situations the tissue graft is placed on the raw surface of soft tissue or bone surface and sutured in place. Oral surgery may also be required where the patient has oral cancer. For instance, lower gingival squamous cell carcinoma (SCC) can invade the mandibular bone and buccal mucosa. In such situations, en bloc surgery of malignant tumors can require reconstructive surgery such as segmental mandibulectomy and reconstruction of the mandible and intraoral mucosa with fibular flap.

In other situations, peri-implant plastic surgery harmonizes peri-implant structures by means of hard tissue engineering and soft tissue engineering and can include bone structure enhancement, soft tissue enhancement, precision implant placement and prosthetic restoration. For an implant, bone augmentation can provide a gain in bone height, soft tissue augmentation and then surgical crown lengthening. Another surgery is associated with encapsulated bovine bone that requires abutment replacement with a new temporary crown, bovine bone removal and connective tissue graft insertion for soft tissue contouring.

It is also common for a patient or the dentist to be concerned with gingival recession both from gum and tooth health as well esthetic concerns. Gingival recession can occur due to age or from periodontal disease. Gingival recession is the exposure of portion of the root portion of a tooth due to the apical migration of the attached gingiva as referred to as the gingival tissue margin. The gingival margin migrates apical to the cementoenamel junction (CEJ), e.g., the distance between the CEJ and the gingival margin increases. These result in vestibular depth and inadequate width of keratinized gingiva. Such recession makes the tooth appear to be elongated (long in the tooth) but can, in some cases, result in increased thermal and tactile sensitivity of the exposed dentin, esthetic complaints, a tendency towards root caries, and in some cases a loss of the tooth. Gingival recession occurs wherein periodontal disease exists or due to inflammations of the gums, where incorrect flossing or over-aggressive brushing of the teeth, incorrect occlusal relationships as well as a condition of dominant roots. Gingival recession can occur where there is a loss of attached gingiva but can also occur where no loss of attached gingiva has occurred. When gingival recession occurs, the cervical dentine is uncovered or becomes exposed that can result in the development of root caries as root surfaces become exposed to the oral environment. This can result in the withholding of plaque development and retention and caries lesions. As known, the alveolar crest supports the overlying gingival tissue. It follows the curvature of the cementoenamel junction (CEJ) at an approximate constant distance of about 1 mm. Treatment of recession includes re-contouring of the gingival tissue into a scalloped one. Techniques have also included rebuilding the lost papillae and not reshaping them in a more apical level. Where there is a truncated papillae, rebuilding can include a combination of free connective tissue grating and coronally positioned flaps. Such surgery can include buccal submarginal incisions that enable papilla reconstruction and dissections as a partial thickness on the buccal aspect to leave connective tissue over the interproximal region. This can also involve the grafting of tissue from one region of the mouth, introduction of comparable tissues or tissue regeneration techniques.

To address gingival recession, coverage of the root can be made via various surgical root coverage techniques. These include by way of example, subepithelial connective tissue grafting, coronally advanced flap surgery, free epithelialized gingival grafting, and guided tissue regeneration. For example, the coronally advanced flat surgery requires both semilunar incisions and intracrevicular incisions wherein a flap can be repositioned coronally to increase in the root coverage and reduction in the gingival recession. Others surgeries of the gingiva include intrasulcular incisions at the tooth surface facing the interdental area that is being reconstructed, facial aspect incisions of the interdental area, elevation of an envelope-type split-thickness flap, connective tissue grafting such as from the palate and suturing of a transplanted connective donor graft tissue and/or placement of tissue regeneration materials.

In many of situations, the buccal and/or lingual gingiva is disrupted or modified and is sensitive to further post-operative disruption that can negatively affect the proper healing of the buccal and/or lingual gingiva where the surgery has occurred. The inventor hereof has considered this and found a need for supporting the lingual gingiva while separately and differently supporting the operative buccal and/or lingual gingiva and medicaments applied thereto that has not be met by other assemblies or methods. The inventor hereof is also the inventor that developed the novel periodontal medicament delivery tray that has been used for treatment of periodontal disease as described as the PerioTray® in U.S. Pat. No. 6,966,773 and a positive pressure tray in U.S. Pat. No. 8,591,229. Those prior periodontal trays provide an excellent assembly for use in treatment of periodontal disease by sealing firmly and tightly about the buccal and lingual gum lines and about all of the enclosed teeth for providing delivery of medicaments about the teeth and gums and into the CEJ thereof. However, those trays are not often suited to periodontal surgery due to their seals that are biased (asserting a pressure) against the buccal and lingual gingiva, the latter of which is the site of the surgery. As such, the inventor hereof has identified the need for a new tray assembly, assembly and method of use during and after surgery of the buccal and/or lingual gingiva for supporting the enclosed associated lingual gingiva so that they are no defected or inadvertently altered during surgery, and for supporting the enclosed associated buccal and/or lingual gingiva during and following surgery post-operative recovery which can last for 6 to 8 weeks or more.

### SUMMARY

The inventor hereof has succeeded at designing an assembly, a assembly and methods of manufacture and use for supporting the associated buccal and/or lingual gingiva during surgery so that they are not deflected or inadvertently altered when operating on the buccal and/or lingual gingiva and then to also support and protect and provide medicament to the buccal and/or lingual gingiva where the surgery occurred following the surgery and that can do so during the full post-operative period.

In one aspect, an apparatus for gum tissue support during and after periodontal surgery includes a body configured to be fitted about a portion or all of the upper or lower teeth of a patient, the body having walls that include a buccal wall defining a buccal wall end. The body also has an opposing lingual wall defining a lingual wall end, and a tooth covering portion forming a cavity for enclosing the teeth and coupling the buccal wall and the lingual wall in positions opposing the buccal end and the lingual end, the cavity defining one or more internal recesses for enclosing one or more of the enclosed teeth. The body is composed of resilient elastomeric material molded that conforms the buccal wall end or at least a buccal raised seal on an inside portion thereof to a buccal gum line of the gum tissue and the lingual wall to the opposing lingual gum line of the lingual gum tissue. The assembly also has a lingual raised seal formed longitudinally on an inner surface of the lingual wall corresponding to a location along the lingual gum line of the gum tissue of the patient. The raised lingual seal extends about the lingual gum tissue and spaced apart from an exposed portion of the teeth and applies, when placed on the gums, a lingual biasing pressure to the lingual gum line to support and stabilize the lingual tissue to prevent deflection and alteration. The buccal wall extends substantially from the exposed portion of the tooth to enclose a spaced apart portion of the gum tissue therefrom and is contoured concavely outward from the gum tissue along the gum line forming a medicament holding chamber between an inner surface of the buccal wall and the buccal gum tissue.

In another aspect, an assembly for gum tissue support during and after periodontal surgery includes a body configured to be fitted about a portion or all of the upper or lower teeth of a patient. The body has walls that include a buccal wall defining a buccal wall end, an opposing lingual wall defining a lingual wall end, and a tooth covering portion forming a cavity for enclosing the teeth and coupling the buccal wall and the lingual wall in positions opposing the buccal end and the lingual end. The cavity defines one or more internal recesses for enclosing one or more of the enclosed teeth. The body is composed of resilient elastomeric material molded so that the buccal wall conforms to a buccal gum line of the gum tissue and the lingual wall to the opposing lingual gum line of the lingual gum tissue. A lingual raised seal is formed longitudinally on an inner surface of the lingual wall corresponding to a location along the lingual gum line of the gum tissue of the patient. The raised lingual seal extends about the lingual gum tissue and is spaced apart from an exposed portion of the teeth and is configured to apply a lingual biasing pressure to support and stabilize the lingual tissue to prevent deflection and alteration. The buccal wall extends substantially from the exposed portion of the tooth to enclose a spaced apart portion of the gum tissue therefrom and is contoured concavely outward from the gum tissue along the gum line forming a medicament holding chamber between an inner surface of the buccal wall and the buccal gum tissue. A medicament lining is composed of a pliable medicated material and is configured for selective placement in the medicament holding chamber between the inner surface of the buccal wall and the buccal gum tissue.

In yet another aspect, a method of supporting gum tissue during and after periodontal surgery includes several steps. Prior to surgery to mandibular or maxillary gum tissue having associated one or more teeth, the method includes preparing a tray for receiving and enclosing the associated teeth and an extended portion of the buccal and/or lingual gingiva tissue. The step of preparing includes creating a tray that has a body fitted about a portion or all of the upper or lower teeth of a patient and walls that include an buccal wall defining a buccal wall end, an opposing lingual wall defining a lingual wall end, and a tooth covering portion forming a cavity for enclosing the teeth and coupling the buccal wall and the lingual wall in positions opposing the buccal end and the lingual end, the cavity defining one or more internal recesses for enclosing one or more of the enclosed teeth. The body is composed of resilient elastomeric material molded that conforms a portion of the buccal wall to a buccal gum line of the gum tissue and the lingual wall to the opposing lingual gum line of the lingual gum tissue. The preparing step also includes forming a lingual raised seal longitudinally on an inner surface of the lingual wall corresponding to a location along the lingual gum line of the gum tissue of the patient. The formed raised lingual seal extends about the lingual gum tissue and spaced apart from an exposed portion of the teeth and is formed to apply a lingual biasing pressure to the lingual gum line to support and stabilize the lingual tissue to prevent deflection and alteration. The forming also includes forming the buccal wall to extend substantially from the exposed portion of the tooth to enclose a spaced apart portion of the gum tissue therefrom and is contoured concavely outward from the gum tissue along the gum line forming a medicament holding chamber between an inner surface of the buccal wall and the buccal gum tissue. The method also includes preparing a medicament lining that is composed of a pliable medicated material for selective placement in the medicament holding chamber between the inner surface of the buccal wall and the buccal gingiva tissue, or lingual wall and gingiva as may be applicable. The method further includes placing the prepared tray and the prepared medicament lining about the buccal and/or lingual gingiva tissue.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a front view of a buccal maxillary tooth and gums of a patient.

FIG. 2 is a cross-sectional view of a healthy tooth and gingival tissue.

FIG. 3A is a top perspective view of a periodontal surgery tray according to one exemplary embodiment of the present disclosure.

FIG. 3B is a bottom view of a periodontal surgery tray according to one exemplary embodiment of the present disclosure.

FIG. 4 is a side cross sectional view of a periodontal surgery tray applied to gingiva and a tooth according to one exemplary embodiment.

FIG. 5 is a side cross sectional view of a periodontal surgery tray applied to gingiva and a tooth according to another exemplary embodiment.

FIG. 6A is a side cross sectional view of a tooth and gum prior to periodontal surgery and application of a periodontal surgery tray.

FIG. 6B is a side cross sectional view of the tooth and gum of FIG. 6A with a periodontal surgery tray applied to the gingiva and tooth according to one exemplary embodiment.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses. Before turning to the figures and the various exemplary embodiments illustrated therein, a detailed overview of various embodiments and aspects is provided for purposes of breadth of scope, context, clarity, and completeness. As should be understood by one of ordinary skill in the art, the various references are made herein as to the buccal and lingual gingiva and walls, etc., are exemplary in nature and such discussion is by way of example and that each statement herein is intended to include either or both of the lingual and buccal gingiva.

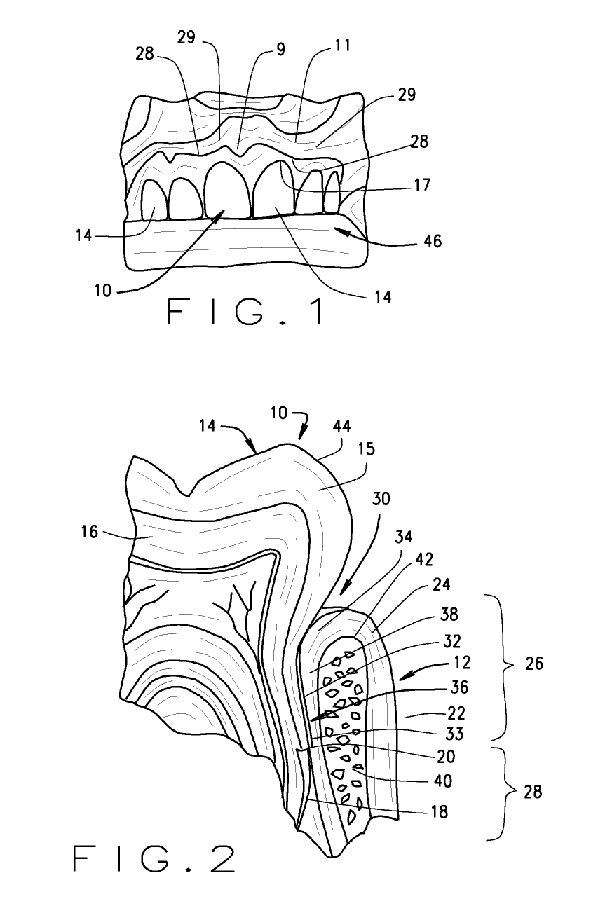

FIG. 1 shows a front view of a patient's maxillary teeth 10 and gums 12 portions. The primary exposed portion of the teeth 10 is a crown 14 with the cheek or outer exposed portion being a buccal side 46 forming an inner buccal wall surface 373 and the opposing surface or portion being towards the mouth cavity being a lingual side 48 forming the lingual inner surface 273. The teeth 10 intersect with the attached gingiva 28 at the gingival margin 17. The attached gingiva 28 intersects with the unattached gingiva 29 at the mucogingival junction 31 which then attaches at the opposing end at the labial vestibule 11. In the center is the maxillary labial frenum 9. The clinical importance of the mucogingival junction 31 is in measuring the width of attached gingiva 28. Attached gingiva 28 is important as it is bound tightly to the underlying alveolar bone 40 and provides protection to the mucosa including the epithelium 32 and an underlying lamina propria of connective tissue 34.

FIG. 2 shows a healthy tooth 10 with surrounding gum 12. The tooth 10 includes a crown 14 having enamel 15, an inner composition of dentine 16 that forms the root of the tooth 10, and cementum 18 that covers the outer surface of the lower portions of the tooth 10 below the enamel 15. A cementoenamel junction (CEJ) 20 is defined as the intersection of the lower end of the enamel 15 and the start of the cementum 18. As shown, the gum 12 includes gingiva 22 on the buccal side 46 referred herein as buccal gingiva 322 and on the lingual side 48 as the lingual gingiva 222 that has gingival tissue 24 having a portion referred to as marginal gingiva tissue 26, and attached gingiva tissue 28, the two portions generally being separated by the CEJ 20. On each side, the gum 12 forms a gingival sulcus 30 at the intersection with the tooth 10 and forms a gum line 60 longitudinally with the teeth 10, with the one on the buccal side 46 being the buccal gum line 360 and the one on the lingual side 48 being the lingual gum line 260. An epithelium 32 covers the lower portions of the enamel 15 above the CEJ 20 such that the cementum 18 is not exposed in a healthy tooth 10 as shown. Connective tissue 34 of the gingiva tissue 24 is adjacent to the epithelium 32 (this portion referred to as the junctional epithelium 33) and includes a bed of capillaries, hereinafter referred to as a capillary bed 36, and alveolar fibers 38. An alveolar bone 40 has an alveolar crest 42 that extends nearly to the CEJ 20 to form a deep socket (not shown) for the tooth 10. Biofilm 44 generally forms to coat the outer surface of the enamel 15.

As noted, the present inventor originally created the PerioTray™ for use for the treatment of periodontal disease. The inventor's original PerioTray™ was first described in U.S. Pat. No. 6,966,773 (“'773 Patent”). Such earlier tray was a novel design specifically well suited for applying a medicament under pressure about the enclosed teeth 10 and to force the medicament into the gingival sulcus 30 between the tooth 10 and the gingiva 22. To accomplish this, the novel tray had a seal formed to be disposed on the inner wall about the gum line to form a substantially airtight seal to enable a pressure to be formed in the cavity and to enclose and capture the medicament against and into all areas about the teeth and gum tissue at or near the gingival sulcus.

The present invention differs at to the prior periodontal medicament tray of the inventor's '773 Patent in that the present tray is not used for placement of a medicament about the teeth and gums as is the tray of the '773 Patent, but has been designed for use before, during and after periodontal surgery of the buccal and/or lingual gingiva and similar periodontal surgery as may be suitable and adaptable as one of skill in the art would understand from the present disclosure.

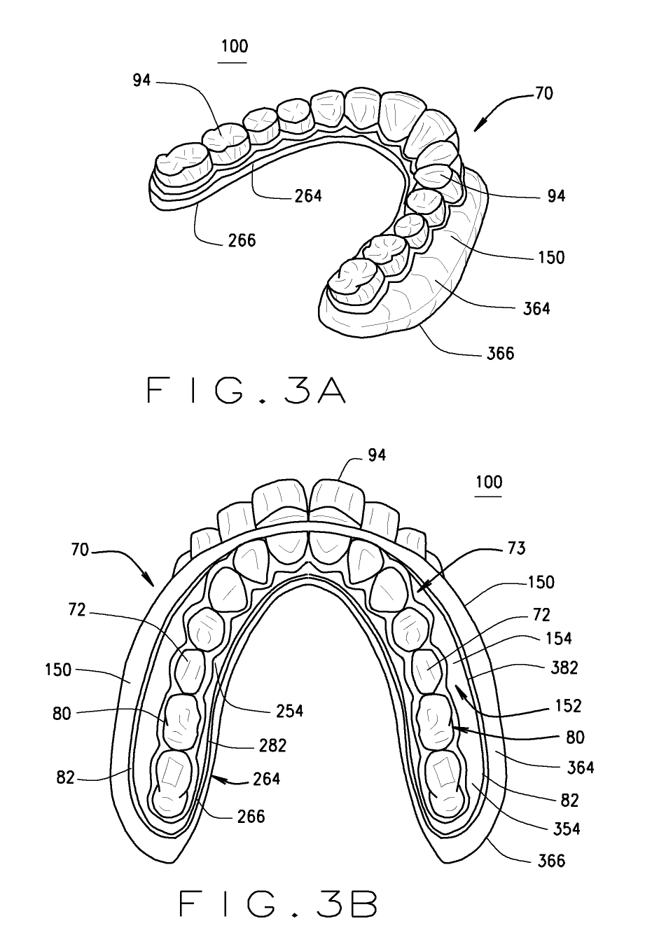

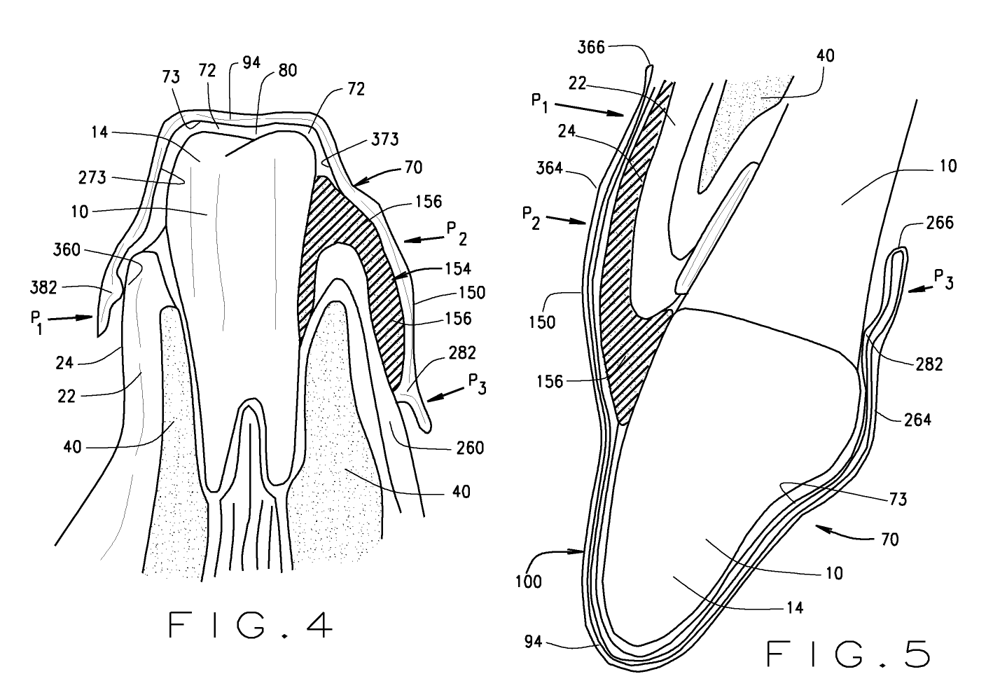

FIGS. 3A and 3B provide a top view and a bottom view respectively of a periodontal surgery tray 100 according to one embodiment of this disclosure. In this embodiment, the surgery tray 100 can be composed of any suitable material but in some embodiment is formed from a soft plastic elastomeric which is molded via stone molding to the patient's teeth 10 so as to form a cavity 80 that conforms closely to a patient's teeth 10 as well as the portions of the gingiva 22. This could be on the lingual side 48 for the lingual gingiva 222 or on the buccal side 46 for the buccal gingiva 322, but in this example, will be described on the lingual side 48 and lingual gingiva 222 by way of example, and forming a wall 64, such as a lingual wall 264 and a buccal wall 364. The periodontal surgery tray 100 is shown to be a full arch tray, but those skilled in the art will recognize that a partial arch tray or a dual arch tray may also be used, if desired, and is within the scope of the present disclosure and definition of periodontal surgery tray 100. In one embodiment, where surgery is to be performed on the lingual side 48 such as the lingual gingiva 222, the tray 100 can be formed to have an inner surface lingual seal 282 on an inner surface 273 of the lingual wall 264. The lingual seal 282 is formed in proximity to or offset from the lingual gingival margin 217 and can be at or near the lingual end 266 of the lingual tray wall 264. The lingual seal 282 is typically formed on the area of the stone impression (not shown), and in one embodiment is formed on the stone in a formed cavity thereof, such that the seal 82 is a raised or extends outward from the wall 64 on which the seal 82 is formed, for contacting and engaging the gingiva tissue 24 to form a seal that is greater than the other portions of the formed wall 64. The tray 100 with the lingual seal 282 is formed for supporting the lingual gingiva tissue 224. In one embodiment the lingual seal 282 is formed longitudinally on the inner surface 273 of the lingual wall 264 corresponding to a location along the lingual gum line 260 of the lingual gingiva tissue 224 of the patient. The lingual seal 282 can extend about the lingual gingiva tissue 224 and can be spaced apart from an exposed portion of the teeth 10. To provide for stabilization of the lingual gingiva tissue 224 during surgery, the lingual wall/skirt 264 and lingual seal 282 can be formed to apply a lingual biasing pressure P1 to the lingual gum line 260 to support and stabilize the lingual tissue 224 to prevent deflection and alteration of the lingual gingiva tissue 224 during and following the periodontal surgical process thereon.

As shown, the opposing wall, such as the buccal wall 364 of the tray 100 when for surgery of the buccal gum tissue 324, can extend about a greater length formed on the stone so that the buccal wall 364 extends further onto the inner buccal wall surface 373 when placed on a patient. In this manner, wall 64 of the tray 100 that is on the same side of the teeth 10 from which surgery is being performed, such as the buccal wall 364 for surgery on the buccal gum tissue 324 will extend substantially up onto and about a substantial portion of the buccal gum line 360 up and in proximity to the buccal mucogingival junction 331 as the buccal attached gingival 328. In this manner, the buccal wall 364 extends to support the subject periodontal surgical tissue 324 for which the tray 100 is configured for use during and after periodontal surgery thereof. A buccal wall 364 has a buccal wall end 366 and a buccal seal 382 can be longitudinally on the inner buccal wall surface 373 of the buccal wall 364 at or near the buccal end 366 and can be formed similar on the stone during preparation but in a different location on the gum line 60. In some embodiments, the buccal wall 364 is not formed on the stone to conform to the preoperative profile of the buccal and/or lingual gingiva 22 (322, 222 respectively) and in some embodiments in particular the attached gingiva 28 and possibly also a portion of the tooth crown 14 that is proximate to the gingival margin 17, but rather is formed to have an outward/buccal bulge 150 to form an inner concave cavity 152 on the inside of the wall 64 to form a medicament holding chamber 154. The medicament holding chamber 154 is contoured as a bulge to form the inner concave medicament holding chamber 154 for receiving a medicament lining 156 between the inner wall 64 and the post-operative gingiva tissue 24. The buccal wall 364, the buccal medicament holding chamber 354, and the buccal raised seal 382 (where present in such embodiment) are formed for applying a medicament holding pressure or biasing inward from the buccal wall 364 about the buccal medicament holding chamber 354 to the enclosed buccal and/or lingual gingiva tissue 24 when a medicament lining 156 is placed within the medicament gap 154. Further, where the seal 82 is formed as a raised seal 82 on the wall 64, the tray 100 is formed for providing a buccal biasing pressure inward against the contacting buccal and/or lingual gingiva 22 with a force P3.

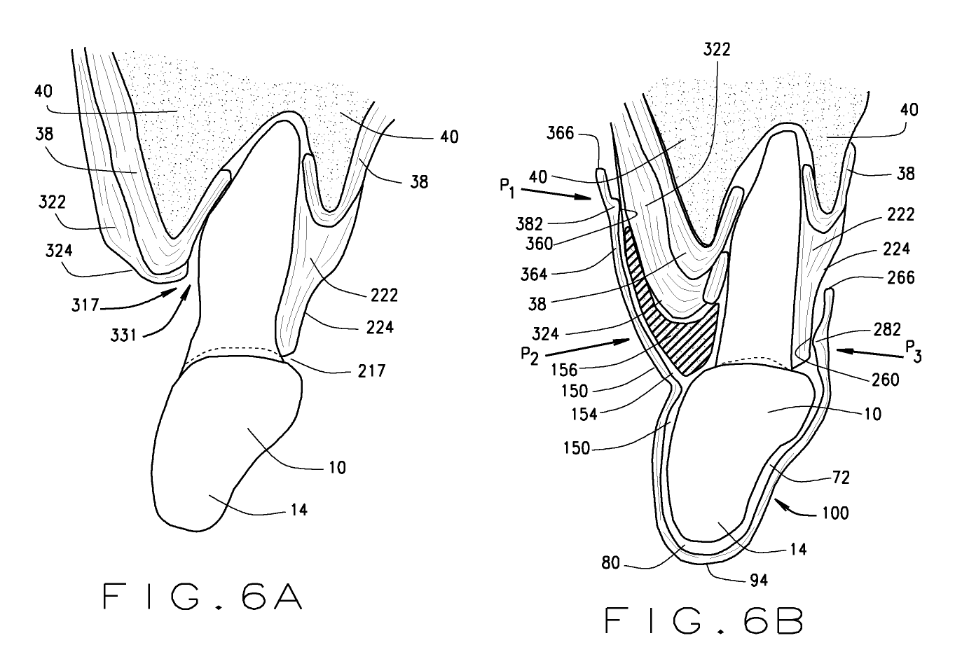

As also shown in FIGS. 5 and 6B, an apparatus 100 provides an assembly for supporting gum tissue 324 during and after periodontal surgery has a body 70 configured to be fitted about a portion or all of the upper or lower teeth 10 of a patient, the body 70 having walls 64 that include a buccal wall 364 defining a buccal wall end 366. The body 70 is composed of resilient elastomeric material molded that conforms the end 366 of the buccal wall 364 including any buccal seal 382 thereon to a portion of the buccal gum line 360 of the gum tissue 324 and the lingual wall 264 to the opposing lingual gum line 260 of the lingual gingiva tissue 224.

One or more recesses 72 can be defined by the cavity 80 and dimensioned to enclose the crown 14 of the enclosed tooth 10. Each recess 72 can be dimensioned to enclose the crown 14 of each enclosed tooth 10 in a tight fit configuration. The buccal wall 364 of the tray 100 can be configured to apply an atypical biasing force F along the inner surface 373 of the medicament holding chamber 354.

The body 180 also has an opposing lingual wall 264 defining a lingual wall end 266, and a tooth covering portion 94 forming the cavity 80 for enclosing the teeth 10 and coupling the buccal wall 364 to the lingual wall 264 in positions opposing the buccal end 366 and the lingual end 266. The cavity 80 therebetween defines one or more internal recesses 72 for enclosing the one or more of the enclosed teeth 10. The lingual wall 264 can have a length D_{LW} that is less than the length D_{BW} of the buccal wall 364 as compared to the crown 14 of the enclosed teeth 10.

In some embodiments of the assembly 100 having a raised lingual seal 282 formed longitudinally on the lingual wall inner surface 273 of the lingual wall 264 corresponding to a location along the lingual gum line 260 of the gingiva tissue 224 of the patient. The raised lingual seal 282 extends about the lingual gingiva tissue 224 and spaced apart from an exposed portion of the teeth 10 and applies, when placed on the gums, a lingual biasing pressure P3 to the lingual gum line 260 to support and stabilize the lingual tissue 224 to prevent deflection and alteration before, during, and/or after surgery thereof. The lingual raised seal 282 can be configured to provide a substantially air tight seal against the lingual gingiva tissue 224.

The buccal wall 364 can extend substantially from the exposed portion of the tooth 10 to enclose a spaced apart portion of the gum tissue 324 therefrom and can be contoured concavely outward from the gum tissue 324 along the buccal gum line 320 forming a medicament holding chamber 354 between an inner buccal wall surface 373 of the buccal wall 364 and the buccal gum tissue 324. The medicament holding chamber 354 is formed and positioned in an area of the buccal wall 364 that is in proximity to a surgical procedure such as an incision or graft of the buccal gum tissue 324 and configured such that that biasing force F3 supports the received medicament lining 156 without adversely affecting the surgical procedure or the surgical area of the buccal gum tissue 324. The formed medicament holding chamber 354 can be formed parallel with the enclosed buccal gum tissue 324.

The portion of the buccal wall 364 forming the medicament holding chamber 354 can protrude outwardly from the gum tissue 324 such as an outward formed bulge.

The buccal wall can be configured for applying an atypical biasing force along the inner surface 73 of the medicament holding chamber 354. The medicament holding chamber 354 can be formed and positioned in an area of the buccal 364 wall that is in proximity to a planned surgical procedure such as an incision or graft of the buccal gum tissue 324.

As noted, in some embodiments, a buccal raised seal is formed longitudinally on the inner buccal wall surface 373 of the buccal wall 364. The raised buccal seal 382 can extend about the buccal gum tissue 324 and can be spaced apart from an exposed portion of the teeth 10 and/or the buccal and/or lingual gingival margin 217. The buccal seal 382 can be configured to apply a buccal sealing biasing pressure to the buccal gum line 360 to form a substantially air tight seal against the buccal gum tissue 324 and sealing the medicament holding chamber 354. The buccal seal 382 and buccal wall 364 can be configured to provide a substantially air tight seal against the buccal gum tissue 324. Where both are provided, the lingual seal 282 and the buccal seal 382 can form the cavity 80 to be substantially air tight. The buccal raised seal 382 can be positioned adjacent to or at the buccal wall end 366. The buccal wall 364 can be configured for applying an atypical biasing force along the inner buccal wall surface 373 of the medicament holding chamber 354, such atypical biasing force being separate from the buccal biasing pressure applied to the buccal gum line 360.

The buccal and lingual walls 366, 266 can be composed of a common material of the tray body 70 or can be formed from a material having substantially less elastic resilience than a material forming the tooth covering portion 94.

In another embodiment, an assembly 100 for gum tissue support during and after periodontal surgery includes a body 70 configured to be fitted about a portion or all of the upper or lower teeth 10 of a patient. The body 70 has walls that include a buccal wall 364 defining a buccal wall end 366, an opposing lingual wall 264 defining a lingual wall end 266, and a tooth covering portion 94 forming a cavity 80 for enclosing the teeth 10 and coupling the buccal wall 364 and the lingual wall 264 in positions opposing the buccal end 366 and the lingual end 266. The cavity 80 defines one or more internal recesses 72 for enclosing one or more of the enclosed teeth 10. The body 70 is composed of resilient elastomeric material molded that conforms the buccal wall 364 or a contacting portion thereof (not the buccal medicament holding chamber 354 or bulge) to a buccal gum line 360 of the gum tissue 324 and the lingual wall 264 to the opposing lingual gum line 260 of the lingual gingiva tissue 224. A lingual raised seal 282 is formed longitudinally on the lingual wall inner surface 273 of the lingual wall 264 corresponding to a location along the lingual gum line 260 of the gingiva tissue 224 of the patient. The raised lingual seal 282 extends about the lingual gingiva tissue 224 and is spaced apart from an exposed portion of the teeth 10 and is configured to apply a lingual biasing pressure to support and stabilize the lingual tissue 224 to prevent deflection and alteration. The buccal wall 364 extends substantially from the exposed portion of the tooth 10 to enclose a spaced apart portion of the gum tissue 324 therefrom and is contoured concavely outward from the gum tissue 324 along the gum line 360 forming a medicament holding chamber 354 between the an inner buccal wall surface 373 of the buccal wall 364 and the buccal gum tissue 324. A medicament lining 156 is composed of a pliable medicated material and is configured for selective placement in the medicament holding chamber 154 between the inner buccal wall surface 373 of the buccal wall 364 and the buccal gum tissue 324.

The assembly 100 can be as described above by the one or more embodiments or various thereof. In practice, the assembly 100 includes the assembly 100 as well as including a colloidal bone material (not shown) that can be placed between the buccal and/or lingual gingiva tissue 224 and the root of the enclosed tooth 10 during surgery. This can be an injectable colloidal bone material that is settable after injection. This can be in addition to a collagen that is also placed between the buccal and/or lingual gingiva tissue 224 and the root of the enclosed tooth 10.

In another embodiment, a method of supporting gum tissue 24 during and after periodontal surgery includes several steps. Prior to surgery to mandibular or maxillary gum tissue 24 having associated one or more teeth 10, the method includes preparing a tray 100 for receiving and enclosing the associated teeth 10 and an extended portion of the buccal gingiva tissue 324 or lingual gingiva tissue 224. The step of preparing includes creating a tray 100 that has a body 70 fitted about a portion or all of the upper or lower teeth 10 of a patient and walls 64 (264, 364) that include an buccal wall 364 defining a buccal wall end 366, an opposing lingual wall 264 defining a lingual wall end 266, and a tooth covering portion 194 forming a cavity 80 for enclosing the teeth 10 and coupling the buccal wall 364 and the lingual wall 264 in positions opposing the buccal end 366 and the lingual end 266, the cavity 80 defining one or more internal recesses 72 for enclosing one or more of the enclosed teeth 10. The body 70 is composed of resilient elastomeric material that is molded to the stone impression.

The preparing step also includes forming a lingual raised seal 282 longitudinally on the lingual wall inner surface 273 of the lingual wall 264 corresponding to a location along the lingual gum line 260 of the gingiva tissue 224 of the patient. The formed raised lingual seal 282 extends about the lingual gingiva tissue 224 and spaced apart from an exposed portion of the teeth 10 and is formed to apply a lingual biasing pressure to the lingual gum line 260 to support and stabilize the lingual tissue 224 to prevent deflection and alteration. The forming also includes forming the buccal wall 364 to extend substantially from the exposed portion of the tooth 10 to enclose a spaced apart portion of the gum tissue 324 therefrom and is contoured concavely outward from the gum tissue 324 along the gum line 360 forming a buccal medicament holding chamber 354 between the inner buccal wall surface 373 of the buccal wall 364 and the buccal gum tissue 324.

The method can include preparing a medicament lining 156 that is composed of a pliable medicated material for selective placement in the medicament holding chamber 154 between the inner buccal wall surface 373 of the buccal wall 364 and the buccal gingiva tissue 324, or the same for lingual. The method further can include placing the prepared tray 100 and the prepared medicament lining 156 about the buccal and/or lingual gingiva tissue 224, 224.

The process of preparing the tray 100 can include forming the medicament holding chamber 154 for receiving the prepared medicament lining 156, each being prepared from a periodontal stone formed from an impression of the tooth 100 and gums 12. This can be formed or the process designed so that there is a buccal bias applied by one or both of the buccal wall portions 64 of the tray body 70 forming the medicament holding chamber 354 and the placed medicament lining 156 against the buccal and/or lingual gingiva 324, 224.

The process of preparing and placing of the tray can provide the buccal bias to at least a portion of the preoperative buccal attached gingiva.

The process of preparing and placing of the tray 100 can provide the buccal bias to at least a portion of the preoperative buccal attached gingiva and a portion of the crown of the enclosed tooth 10.

The process of preparing and placing of the tray 100 can provide the buccal bias to a substantial portion of the post-operative buccal attached gingiva.

The process of preparing and placing of the tray 100 can provide the buccal bias to a substantial portion of the post-operative buccal attached gingiva and a portion of the crown of the enclosed tooth.

The process of preparing and placing of the tray 100 can provide the buccal bias to reposition the enclosed post-operative buccal and/or lingual gingiva apically.

The process of providing the tray 100 can include forming a buccal raised seal 382 formed longitudinally on the inner buccal wall surface 373 of the buccal wall 364 and configured for applying a buccal sealing biasing pressure to the buccal gum line 360 to form a substantially air tight seal against the buccal gum tissue 324 and sealing the medicament holding chamber 354.

The process of forming the lingual seal 282 can also include configuring the lingual seal 282 to provide a substantially air tight seal against the lingual gingiva tissue 224 and such can include configuring so that a substantially air tight seal against the buccal gingiva tissue 224, the lingual seal 282 and the buccal seal 382 forming the cavity 80 to be substantially air tight.

The buccal seal 382 can be formed to be positioned adjacent to or at the buccal wall end 366. The buccal wall 364 can be formed for applying an atypical biasing force along the inner buccal wall surface 373 of the medicament holding chamber 354. Such an atypical biasing force can be separate from the buccal sealing biasing pressure applied to the buccal gum line 324.

The process can include forming the medicament holding chamber 354 includes forming and positioning the medicament holding chamber 354 in an area of the buccal wall 364 that is in proximity to a surgical procedure such as an incision or graft of the buccal gum tissue 324. This can be configured or performed to provide a biasing force that supports the received medicament lining 156 without adversely affecting the surgical procedure.

The process can include forming the buccal wall 364 includes forming the buccal wall 364 for applying an atypical biasing force along the inner buccal wall surface 373 of the medicament holding chamber 354.

The process can include forming the medicament holding chamber 354 includes forming and positioning the medicament holding chamber 354 in an area of the buccal wall 364 that is in proximity to a planned surgical procedure such as an incision or graft of the buccal gum tissue 324.

Prior to the placing of the prepared medicament lining 156 about the buccal and/or lingual gingiva tissue 224, 224, the process can include applying to the medicament lining 156 or preparing the medicament lining 156 with an oxygenation agent, an anti-oxidant, a nutritional supplement, a vitamin, an anti-microbial agent, a bone growth stimulant, and an antibiotic, by way of example and not intending to be limited thereto. Of course one or more of these and other agents can be applied simultaneously or separately.

The process can include placing of the prepared tray 100 about the buccal and/or lingual gingiva tissue 224, 224 and the tooth 10 and placing one or more medicaments into the cavity 80 of the tray 100 selected from the group consisting of: an oxygenation agent, an anti-oxidant, a nutritional supplement, a vitamin, an anti-microbial agent, a bone growth stimulant, and an antibiotic, by ways of example.

The process can include preparing the tray 100 by forming the lingual wall 264 to be over the lingual portion of the crown 14 but not substantially spaced apart from the crown 14 along the lingual gingiva 222 proximate to the root for positioning the lingual seal 282 in close proximity to the lingual gingival margin 217.

The process can include preparing the tray 100 by forming the buccal wall end 366 that is proximate to or slightly spaced apart from the post-operative free buccal gingival margin 317.

The process can include preparing a colloidal bone material for placement between the buccal and/or lingual gingiva tissue 224, 224 and the root and placing the prepared colloidal bone material within the buccal and/or lingual gingiva tissue 224, 224 along the buccal side 46 of the tooth root during surgery. This can include a colloidal bone material that is an injecting of the colloidal bone material and the process can include such injecting or otherwise placing the colloidal bone material is in addition to placing a collagen. The process can include selecting the colloidal bone material that is injectable and/or one that sets after placement or injection within an operative or post-operative procedure setting time period.

The process of placing can be continued over an initial period of time. This can include repeating the steps of preparing a tray 100 and a medicament lining 156 a second or more times to prepare a second tray 100 having a second or more bodies 70 with a differently formed medicament holding chamber 154. Each of these can provide second medicament lining 156 for the gap design and the formation of the buccal and/or lingual gingiva 324, 224. This can be after the expiration of the initial post-operative period of time and repeating the step of placing.

The process of preparing the medicament lining 156 and placing the prepared tray 100 and the prepared medicament lining 156 are repeated a plurality of times with the prepared tray 100 over an initial post-operative period of time.

The process of placing the prepared tray 100 with the prepared medicament lining 156 is repeated a plurality of times with the prepared tray 100 and medicament lining 156 over an initial post-operative period of time.

The process of preparing the tray 100 can include forming the medicament holding chamber 354 in an area of the buccal wall 364 in proximity to a planned surgical procedure such as an incision or graft of the buccal gum tissue 324.

The process of preparing the buccal medicament holding chamber 354 can include positioning the medicament holding chamber 354 in an area of the buccal wall 364 that is in proximity to a surgical procedure, or a planned surgical procedure such as an incision or graft of the buccal gum tissue 324 and configured such that that a biasing force supports the received medicament lining 156 without adversely affecting the surgical procedure.

The process of forming the medicament holding chamber 354 can include forming and positioning the medicament holding chamber 354 in an area of the buccal wall 364 that is in proximity to a planned surgical procedure such as an incision or graft of the buccal gum tissue 324.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. An oral apparatus for gum tissue support during and after periodontal surgery comprising:
a body configured to be fitted about a portion or all of the upper or lower teeth of a patient, the body having walls that include an buccal wall defining a buccal wall end, an opposing lingual wall defining a lingual wall end, and a tooth covering portion forming a cavity for enclosing the teeth and coupling the buccal wall and the lingual wall in positions opposing the buccal end and the lingual end, the cavity defining one or more internal recesses for enclosing one or more of the enclosed teeth, the body composed of resilient elastomeric material molded to conform the buccal wall to a buccal gum line of the gum tissue and the lingual wall to the opposing lingual gum line of the lingual gum tissue; and
a lingual raised seal formed longitudinally on an inner surface of the lingual wall corresponding to a location along the lingual gum line of the gum tissue of the patient, the raised lingual seal extending about the lingual gum tissue and spaced apart from an exposed portion of the teeth, and applying a lingual biasing pressure to the lingual gum line to support and stabilize the lingual tissue to prevent deflection and alteration,
wherein the buccal wall extending substantially from the exposed portion of the tooth to enclose a spaced apart portion of the gum tissue therefrom and contoured concavely outward from the gum tissue along the gum line forming a medicament holding chamber between an inner surface of the buccal wall and the buccal gum tissue.

2. The oral apparatus of claim 1, further comprising a buccal raised seal formed longitudinally on an inner surface of the buccal wall, the raised buccal seal extending about the buccal gum tissue and spaced apart from an exposed portion of the teeth, and applying a buccal sealing biasing pressure to the buccal gum line to form a substantially air tight seal against the buccal gum tissue and sealing the medicament holding chamber.

3. The oral apparatus of claim 2 wherein the lingual raised seal is configured to provide a substantially air tight seal against the lingual gum tissue and configured for providing a substantially air tight seal against the buccal gum tissue, the lingual and buccal seals forming the cavity to be substantially air tight.

4. The oral apparatus of claim 2 wherein the buccal raised seal is positioned adjacent to or at the buccal wall end.

5. The oral apparatus of claim 2 wherein the buccal wall is configured for applying an atypical biasing force along the inner surface of the medicament holding chamber, such atypical biasing force being separate from the buccal biasing pressure applied to the buccal gum line.

6. The oral apparatus of claim 4 wherein the medicament holding chamber is formed and positioned in an area of the buccal wall that is in proximity to a surgical procedure such as an incision or graft of the buccal gum tissue and configured such that that biasing force supports the received medicament lining without adversely affecting the surgical procedure.

7. The oral apparatus of claim 1 wherein the buccal wall is configured for applying an atypical biasing force along the inner surface of the medicament holding chamber.

8. The oral apparatus of claim 1 wherein the medicament holding chamber is formed and positioned in an area of the buccal wall that is in proximity to a planned surgical procedure such as an incision or graft of the buccal gum tissue.

9. The oral apparatus of claim 1 wherein the lingual wall has a length that is less than the length of the buccal wall as compared to the crown of the enclosed teeth.

10. The oral apparatus of claim 1 wherein each of the one or more recesses defined by the cavity is dimensioned to enclose the crown of the enclosed tooth.

11. The oral apparatus of claim 10 wherein each recess is dimensioned to enclose the crown of each enclosed tooth in a tight fit configuration.

12. The oral apparatus of claim 1 wherein the buccal wall is configured for applying an atypical biasing force along the inner surface of the medicament holding chamber.

13. The oral apparatus of claim 1 wherein the medicament holding chamber is formed parallel with the enclosed buccal gum tissue.

14. The oral apparatus of claim 12 wherein the portion of the buccal wall forming the medicament holding chamber protrudes outwardly from the gum tissue.

15. The oral apparatus of claim 1 wherein the buccal and lingual walls are composed of a material having substantially less elastic resilience than a material forming the tooth covering portion.

16. An oral assembly for gum tissue support during and after periodontal surgery comprising:
a body configured to be fitted about a portion or all of the upper or lower teeth of a patient, the body having walls that include an buccal wall defining a buccal wall end, an opposing lingual wall defining a lingual wall end, and a tooth covering portion forming a cavity for enclosing the teeth and coupling the buccal wall and the lingual wall in positions opposing the buccal end and the lingual end, the cavity defining one or more internal recesses for enclosing one or more of the enclosed teeth, the body composed of resilient elastomeric material molded to conform the buccal wall to a buccal gum line of the gum tissue and the lingual wall to the opposing lingual gum line of the lingual gum tissue;
a lingual raised seal formed longitudinally on an inner surface of the lingual wall corresponding to a location along the lingual gum line of the gum tissue of the patient, the raised lingual seal extending about the lingual gum tissue and spaced apart from an exposed portion of the teeth, and applying a lingual biasing pressure to support and stabilize the lingual tissue to prevent deflection and alteration;
wherein the buccal wall extending substantially from the exposed portion of the tooth to enclose a spaced apart portion of the gum tissue therefrom and contoured concavely outward from the gum tissue along the gum line forming a medicament holding chamber between an inner surface of the buccal wall and the buccal gum tissue; and
a medicament lining composed of a pliable medicated material for selective placement in the medicament holding chamber between the inner surface of the buccal wall and the buccal gum tissue.

17. The oral assembly of claim 16, further comprising a buccal raised seal formed longitudinally on an inner surface of the buccal wall, the raised buccal seal extending about the buccal gum tissue and spaced apart from an exposed portion of the teeth, and applying a buccal biasing pressure to the buccal gum line to form a substantially air tight seal against the buccal gum tissue and sealing the medicament holding chamber.

18. The oral assembly of claim 17 wherein the lingual raised seal is configured to provide a substantially air tight seal against the lingual gum tissue and wherein the buccal raised seal is position at or proximate to the buccal end and configured for providing a substantially air tight seal against the buccal gum tissue, the lingual and buccal seals forming the cavity to be substantially air tight.

19. The oral assembly of claim 17 wherein the buccal raised seal is positioned adjacent to or at the buccal wall end.

20. The oral assembly of claim 16 wherein the buccal wall is configured for applying an atypical biasing force along the inner surface of the medicament holding chamber, such atypical biasing force being separate from the buccal biasing pressure applied to the buccal bum line.

21. The oral assembly of claim 20 wherein the medicament holding chamber is formed and positioned in an area of the buccal wall that is in proximity to a surgical procedure such as an incision or graft of the buccal gum tissue and configured such that that biasing force supports the received medicament lining without adversely affecting the surgical procedure.

22. The oral assembly of claim 16 wherein the medicament holding chamber is formed and positioned in an area of the buccal wall that is in proximity to a planned surgical procedure such as an incision or graft of the buccal gum tissue.

23. The oral assembly of claim 16 wherein the lingual wall has a length that is less than the length of the buccal wall as compared to the crown of the enclosed teeth.

24. The oral assembly of claim 16 wherein the each of the one or more recesses defined by the cavity is dimensioned to enclose the crown of the enclosed tooth.

25. The oral assembly of claim 24 wherein each recess is dimensioned to enclose the crown of each enclosed tooth in a tight fit configuration.

26. The oral assembly of claim 16 wherein the buccal wall is configured for applying an atypical biasing force along the inner surface of the medicament holding chamber and against the selectively placed medicament lining.

27. The oral assembly of claim 16 wherein the medicament holding chamber is formed parallel with the enclosed buccal gum tissue.

28. The oral assembly of claim 27 wherein the portion of the buccal wall forming the medicament holding chamber protrudes outwardly from the gum tissue forming a medicament holding cavity for selectively receiving and retaining the medicament lining in the medicament holding chamber.

29. The oral assembly of claim 16 wherein the buccal and lingual walls are composed of a material having substantially less elastic resilience than a material forming the tooth covering portion.

30. The oral assembly of claim 16, further comprising a colloidal bone material for placement between the buccal and/or lingual gingiva tissue and the root of the enclosed tooth.

31. The oral assembly of claim 30 wherein the placing of the colloidal bone material is an injectable colloidal bone material that is settable after injection.

32. The oral assembly of claim 30, further comprising a collagen for placement between the buccal and/or lingual gingiva tissue and the root of the enclosed tooth.
